(19) United States
(12) Patent Application Publication
(10) Pub. No.: US 2025/0188923 A1
(43) Pub. Date: Jun. 12, 2025

(54) PUMP ASSEMBLY

(71) Applicant: Becton, Dickinson and Company, Franklin Lakes, NJ (US)

(72) Inventors: Stephen Robert LaChance, Cockeysville, MD (US); Stefan Campbell Dehaseth, Baltimore, MD (US); Kelsey Ann Graves, Baltimore, MD (US)

(21) Appl. No.: 19/057,351

(22) Filed: Feb. 19, 2025

Related U.S. Application Data
(63) Continuation of application No. PCT/US2023/032701, filed on Sep. 14, 2023.
(60) Provisional application No. 63/376,240, filed on Sep. 19, 2022.

(51) Int. Cl. F04B 53/20; F04B 45/00; F04B 53/10

(52) U.S. Cl. CPC F04B 53/20; F04B 53/10; F04B 45/00

(57) ABSTRACT

The technology described herein generally relates to pump assemblies. The pump assemblies can include a housing, a pump, a suction flow path, a pressure flow path, and a relief valve. The pump can comprise a suction port and a pressure port. The suction flow path can fluidically connect a suction output of the pump assembly to the suction port. The pressure flow path can fluidically connect a pressure output of the pump assembly to the pressure port. The pressure flow path can comprise a reservoir, a first conduit fluidically connecting the pressure port to the interior volume via a first opening of the reservoir, a filter, and a second conduit fluidically connecting the interior volume to the pressure output via a second opening of the reservoir. The relief valve can be configured to exhaust gas and moisture from the interior volume via a third opening of the reservoir.

### CROSS-REFERENCE TO RELATED APPLICATIONS

This application is a continuation of International Application No. PCT/US2023/032701, filed Sep. 14, 2023 which claims the benefit of U.S. Provisional Application No. 63/376,240, filed Sep. 19, 2022, both of which are hereby incorporated by reference in their entirety.

### FIELD

The present disclosure relates to pump assemblies for generating pressure and vacuum. In particular, the disclosure relates to diaphragm pump assemblies capable of reducing the buildup of moisture.

### BACKGROUND

Current pump assemblies used in high humidity environments experience humidity or moisture build up which can damage electronic components within the assembly. Pump assemblies such as diaphragm pumps, progressive cavity pumps, peristaltic pumps, gear pumps, and other similar pumps are frequently used in systems that also contain sensitive electronic components. The electronic components are susceptible to damage if exposed to liquids such as water. Current pump assemblies may cause an undesirable level of condensation that can potentially damage the electronic components when they are used in moderate to high humidity environments. Current pump assemblies typically are not configured to remove or reduce the condensation and/or moisture levels to prevent damage.

### SUMMARY

In a first aspect of the present disclosure, a pump assembly comprises a housing; a pressure output; a suction output; a pump disposed at least partially within the housing and comprising a pressure port in fluid communication with the pressure output and a suction port in fluid communication with the suction output; a reservoir; and a manifold disposed at least partially within the housing between the pump and the reservoir. The manifold comprises a reservoir connection point configured to couple the reservoir to a reservoir facing side of the manifold, the reservoir connection point comprising a first through hole, an interior of the reservoir being in fluid communication with the pressure port of the pump through the first through hole; a second through hole connecting a relief valve to the interior of the reservoir, the relief valve positioned on a pump-facing side of the manifold; and a pressure exit extending through the manifold, the pressure exit fluidically connecting the interior of the reservoir with the pressure output via a moisture control tubing permeable to water vapor.

In some embodiments, the pump assembly further comprises a splatter screen positioned between the relief valve and pump. In some embodiments, the splatter screen is bent at an angle.

In some embodiments, the moisture control tubing is secured away from the pump to prevent the moisture control tubing from contacting the pump.

In some embodiments, the pump assembly can be positioned in a vertical configuration or a horizontal configuration. In some embodiments, the relief valve is at a lower position in the reservoir than the pressure exit in both the vertical configuration and the horizontal configuration. In some embodiments, the manifold is disposed parallel to a direction of gravity in the horizontal configuration and wherein the manifold is disposed perpendicular to the direction of gravity in the vertical configuration.

In some embodiments, the pump assembly further comprises a filter positioned within the reservoir and configured to remove moisture from air passing through the filter. In some embodiments, the filter is disposed adjacent to the first through hole such that fluid entering the reservoir through the first through hole passes through the filter. In some embodiments, the filter is positioned at or near a center of the reservoir connection point.

In some embodiments, the reservoir connection point comprises interior screw threads configured to engage with exterior screw threads of the reservoir to couple the reservoir to the manifold.

In a second aspect of the present disclosure, a pump assembly comprises a housing; a pump comprising a suction port and a pressure port; a suction flow path fluidically connecting a suction output of the pump assembly to the suction port; and a pressure flow path fluidically connecting a pressure output of the pump assembly to the pressure port. The pressure flow path comprises a reservoir surrounding an interior volume; a first conduit fluidically connecting the pressure port to the interior volume via a first opening of the reservoir; a filter configured to remove moisture from gas entering the interior volume from the first conduit; and a second conduit fluidically connecting the interior volume to the pressure output via a second opening of the reservoir. The pump assembly further comprises a relief valve configured to exhaust gas and moisture from the interior volume via a third opening of the reservoir, wherein the third opening is lower than at least the second opening when the pump assembly is installed in a horizontal configuration and when the pump assembly is installed in a vertical configuration.

In some embodiments, the second conduit comprises moisture control tubing permeable to water vapor.

In some embodiments, the pump assembly further comprises a manifold mechanically fixed relative to the pump, wherein the reservoir is coupled to the manifold. In some embodiments, the first, second, and third openings of the reservoir comprise through holes extending through the manifold. In some embodiments, a thickness of the manifold at the second opening is greater than a thickness of the manifold at the third opening. In some embodiments, the manifold is disposed parallel to a direction of gravity in the horizontal configuration and wherein the manifold is disposed perpendicular to the direction of gravity in the vertical configuration.

In some embodiments, the pump assembly further comprises a splatter screen positioned between the relief valve and pump. In some embodiments, the splatter screen is bent at an angle.

In some embodiments, the first and second conduits are secured away from the pump to prevent the conduits from contacting the pump.

### BRIEF DESCRIPTION OF THE DRAWINGS

The above-mentioned aspects, as well as other features, aspects, and advantages of embodiments of the present disclosure will now be described in connection with various implementations, with reference to the accompanying drawings. The illustrated implementations are merely examples and are not intended to be limiting. Throughout the drawings, similar symbols typically identify similar components, unless context dictates otherwise.

FIG. 1 is a perspective view of an example pump assembly in accordance with the present disclosure.

FIGS. 2A-2B are top views of the pump assembly of FIG. 1.

FIGS. 3-4 are side views of the pump assembly of FIG. 1.

FIG. 5 is a front view of the pump assembly of FIG. 1.

FIG. 6 is a rear view of the pump assembly of FIG. 1 with the pump hidden to show manifold components of the pump assembly.

FIGS. 7-8 are cross-sectional side views of the pump assembly of FIG. 1, taken in opposite directions about the central axis L of FIG. 2A.

FIG. 9 is a rear cutaway view of the pump assembly of FIG. 1 illustrating flow paths.

FIG. 10 illustrates the pump assembly of FIG. 1 installed in a horizontal configuration within a system.

FIG. 11 illustrates the pump assembly of FIG. 1 installed in a vertical configuration within a system.

### DETAILED DESCRIPTION

Pumps can be used in various types of systems, one non-limiting example being liquid dispensing systems. For instance, liquid dispensing systems are frequently implemented in automated sample preparation and sample testing systems. The pumps can create both pressure and vacuum. Depending on the intended application of the systems, the pumps can be configured to supply positive pressure and/or negative pressure. In the context of this disclosure, pressure can refer to positive pressure and vacuum can refer to negative pressure. Further, as used in this disclosure, the term “vacuum” does not necessarily imply or require generation of a true vacuum. Rather, “vacuum” in the context of the present disclosure can correspond to generation of suction or a pressure lower than an ambient air pressure, for example.

Embodiments of the present disclosure relate to pump assemblies for generating pressure and vacuum. In particular, the disclosure relates to pump assemblies capable of reducing the buildup of moisture in the pump assemblies and surrounding components. The assemblies can include a single pump that can be used to create both pressure and vacuum. The use of a single pump can allow additional space (for example, when implemented in a pump assembly of a predetermined external size or dimensions) for additional components needed to help reduce or eliminate moisture from the pump assembly.

Removal of all or substantially all moisture may not be necessary for avoidance of equipment damage due to condensation or moisture. In many instances, a partial reduction of the overall percentage of moisture or humidity is sufficient. For example, the pump assemblies of the present disclosure can be configured to lower the humidity to a level where it does not damage the electronics, with significantly less complexity and cost than would be required to remove substantially all moisture from the air. For example, the relative humidity can be reduced to a value around or below 45 percent in some cases, although the actual value may depend on local environmental conditions.

Moreover, in many cases, removal of all or substantially all moisture from a volume of air can actually be problematic because it can create other problems within a system using the pressure and/or vacuum generated at a pump assembly. For example, although the air supplied in a pressure line would be substantially free of moisture, removal of all or substantially all moisture from the pressurized air can create drainage issues when attempting to remove the liquid from the system. This in turn can cause damage to other sensitive or electronic components used in the system, or can require the installation of additional liquid management components (for example, drainage lines, etc.) which can add further time and cost, and may even be impossible to implement due to space or access constraints when installing a moisture-removing pump assembly in a predefined space within an existing piece of equipment.

By removing an intermediate amount of moisture or liquid from the air within a pump assembly, condensation within the system can be avoided while also avoiding the need to properly drain excessive liquid that would be built up if all or substantially all of the liquid were removed. Accordingly, embodiments of pump assemblies of the present disclosure are configured to remove enough moisture from the air being output as pressurized air to prevent damage to downstream electronic components, while also removing an amount of moisture small enough to be handled internally (for example, contained, dispersed, and/or evaporated) within the pump assembly housing without requiring additional liquid management components such as drainage lines or the like.

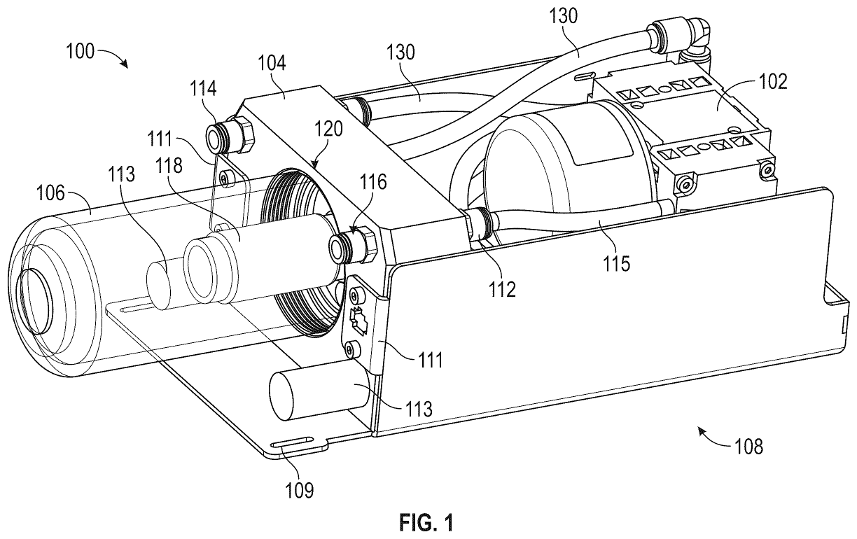

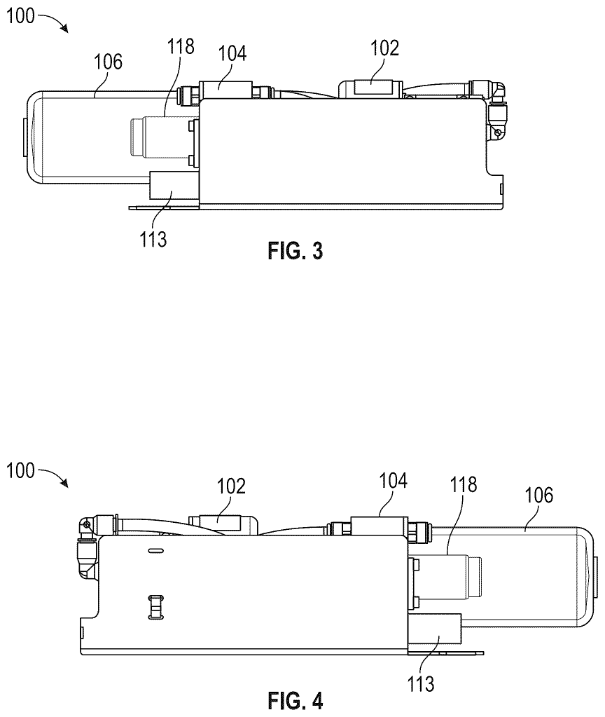

FIGS. 1-4 illustrate an example pump assembly 100 in accordance with the present disclosure. The pump assembly 100 can include a pump 102, a manifold 104, and a reservoir 106. The pump 102 can be disposed at least partially within a housing 108. The manifold 104 can be disposed at least partially within the housing 108 between the pump 102 and the reservoir 106. The pump 102, the manifold 104, and reservoir 106, can be aligned along a central axis L. In alternative embodiments, the pump 102, the manifold 104, and/or the reservoir 106 may not be aligned with the central axis L.

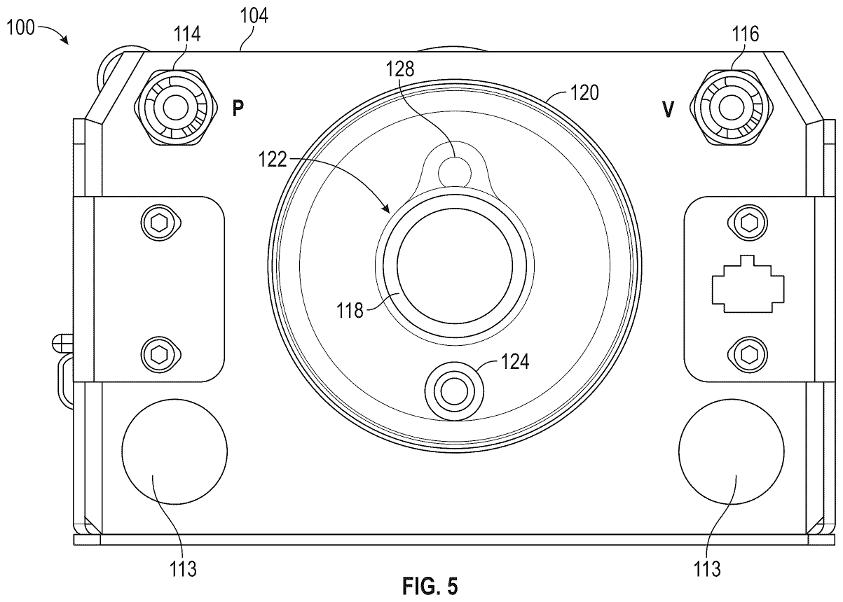

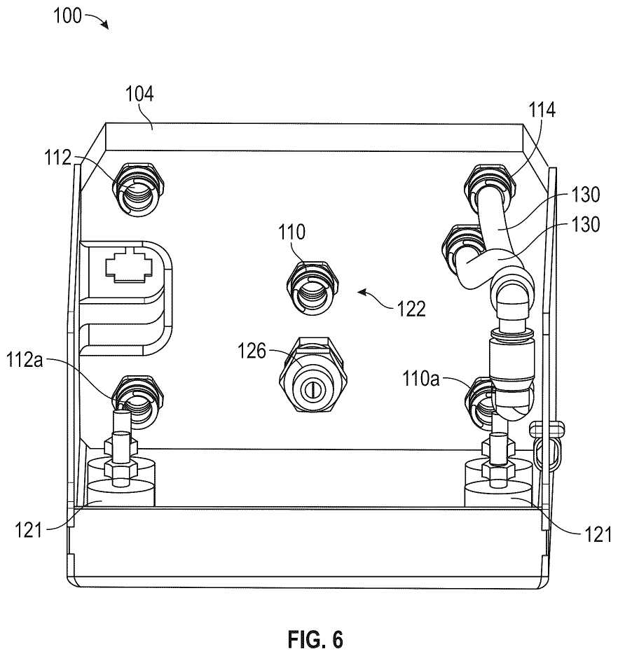

The manifold 104 can be mechanically affixed to the housing 108. The housing 108 can have one or more brackets 111 to attach the manifold 104 to the housing 108. The one or more brackets 111 can attach to a reservoir facing side of the manifold 104. Alternatively, the one or more brackets 111 can attach to a pump facing side of the manifold 104, or the manifold 104 may be attached to the housing 108 by any other suitable mechanical connection. The one or more brackets 111 extend perpendicular to walls of the housing 108. The walls of the housing 108 can extend parallel to the central axis L. The manifold will be described in greater detail below with reference to FIGS. 5-6.

The pump 102 can be a diaphragm pump or other suitable type of pump, and can be configured to create both pressure and vacuum. The pump 102 can have a pressure port 110 and a suction port 112. The pressure port 110 can be in fluid communication with a pressure output 114. The pressure port 110 can be coupled to the pump 102 via a conduit 115. The suction port 112 can be in fluid communication with a suction output 116. The suction port 112 can be coupled to the pump 102 via a conduit or tubing 117. The pump can operate by transporting fluid such as air from the suction port 112 to the pressure port 110, such that a positive pressure is created at the pressure port 110 and a negative pressure is created at the suction port 112.

In some embodiments, the pump 102 can have a second pressure port 110a and a second suction port 112a. The second pressure port 110a and the second suction port 112a can each be coupled to the manifold 104 and respective mufflers 113 via respective conduits 115a, 117a. The mufflers 113 can be positioned on the reservoir facing side of the manifold 104 and extend in a direction parallel to the central axis L. Mufflers 113 can reduce noise in the system by dampening vibrations crated by operation of the pump 102. In addition, mufflers 113 may act as filters to prevent at least some particulate matter and/or debris from entering the pump 102.

In some embodiments, the conduits 115, 115a, 117, 117a can be coupled or secured to the housing 108 to prevent the conduits 115, 115a, 117, 117a from contacting the pump 102. This can prevent wear and tear on the conduits 115, 115a, 117, 117a. For example, if the conduits 115, 115a, 117, 117a are able to contact the pump 102, wear and tear can be caused by the vibration of the pump, friction between the pump 102 and the conduits 115, 115a, 117, 117a, and/or heat generated by the pump 102.

The housing 108 can have one or more coupling features, such as slots 109, which facilitate installation of the pump assembly 100. The one or more slots 109 can be configured to connect the pump assembly 100 to a device, such as by inserting mechanical fasteners (e.g., bolts, screws, or the like) through the one or more slots 109. The one or more slots 109 can be positioned around a base of the housing 108. For example, a pump assembly 100 can have four slots 109 positioned in each corner of the base of the housing 108. However, the slots 109 can be positioned anywhere on the housing 108 and any number of slots 109 can be used. In some embodiments the slots 109 can have an elongate shape to allow for flexibility in positioning the pump assembly 100.

The reservoir 106 can enclose or surround an interior volume. The interior of the reservoir 106 can be in fluid communication with the pressure port 110 of the pump 102 through the first through hole 122. The conduit 115 can fluidically connect the pressure port 110 to the interior volume of the reservoir 106 via the first through hole or opening 122.

The pump assembly 100 can further include a filter 118. The filter 118 can be positioned within the reservoir 106. The filter 118 can be aligned with the first through hole 122 and the pressure port 110. The filter 118 can be configured to remove at least some moisture from air that passes through the filter as the air travels from the pump 102 into the reservoir 106.

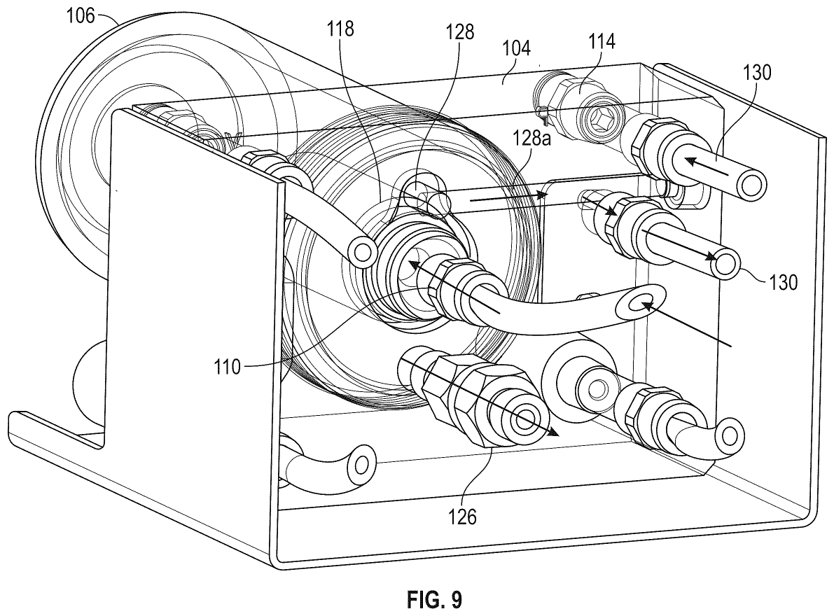

FIG. 5 is a front view of the manifold 104. FIG. 6 is a rear view of the pump assembly 100, with the pump hidden to show pump-facing features of the manifold 104. The manifold 104 can include a reservoir connection point 120. The reservoir connection point 120 can be centrally located in the manifold 104, or can be positioned off-center of the manifold 104. The reservoir connection point 120 can be circular or may be any other suitable shape corresponding to the shape of a connecting portion of the reservoir to be used with the manifold 104. The reservoir connection point 120 can be configured to couple the reservoir 106 to a reservoir facing side of the manifold 104. In some embodiments, an exterior of a connecting portion of the reservoir 106 (see, for example, FIG. 9) can be threaded and an interior of the reservoir connection point 120 can be threaded such that the reservoir 106 can be coupled to the manifold 104 by rotationally engaging the respective threads of the reservoir 106 and the reservoir connection point 120. The reservoir connection point 120 can include a first through hole 122 that extends from the reservoir facing of the manifold 104 to a pump facing side of the manifold 104.

The manifold 104 can include a second through hole 124 connecting a relief valve 126 to the interior of the reservoir 106 and a pressure exit 128. The relief valve 126 can be positioned on the pump-facing side of the manifold 104 and can exhaust gas and/or liquid into the interior of the pump assembly 100. In some embodiments, the configuration including a relief valve 126 can desirably allow the pump assembly 100 to operate continuously when installed in equipment that only uses pressurized air sporadically, rather than turning the pump assembly 100 on and off each time pressurized air is needed. In this case, excess air and/or moisture, which may accumulate within the reservoir 106 while the pump assembly 100 is operating and the equipment is not using pressurized air, can be exhausted through the pressure relief valve. The pressure exit 128 can be connected directly or indirectly to the pressure output 114, as described in greater detail elsewhere herein.

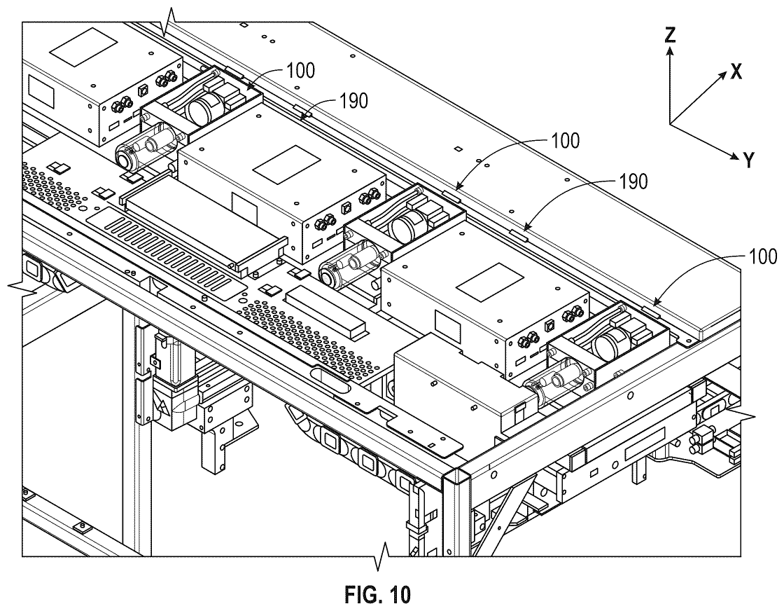

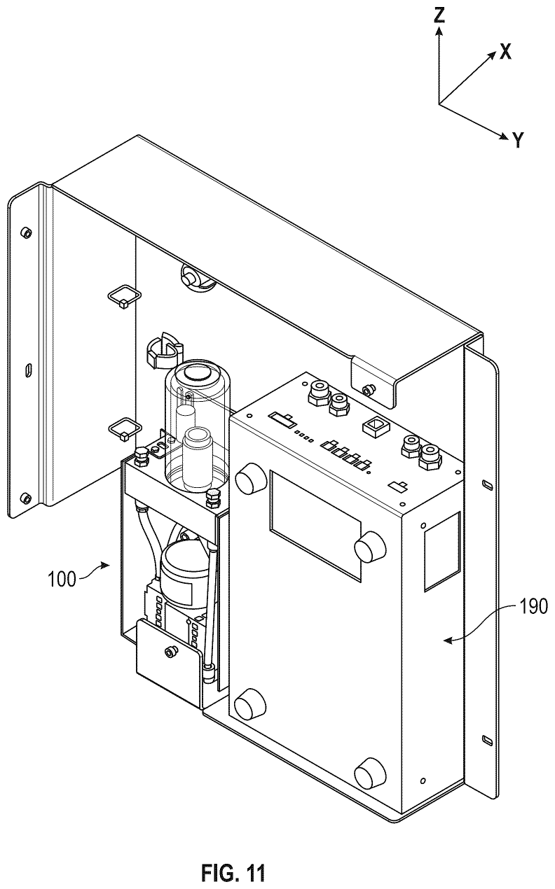

Advantageously, the manifold 104 can be configured such that the second through hole 124 leading to the relief valve 126 is positioned at a lower position in the reservoir 106 than a pressure exit 128 when the pump assembly 100 is installed in either a vertical configuration or a horizontal configuration. In a horizontal configuration, as shown in FIG. 10, the second through hole 124 and the relief valve 126 are positioned below the pressure exit 128. For example, using the coordinate axis shown in FIG. 10, the second through hole 124 and the relief valve 126 are positioned lower on the Z axis then the pressure exit 128. In a vertical configuration, as shown in FIG. 11, the second through hole 124 and the relief valve 126 are still positioned below the pressure exit 128. For example, the second through hole 124 and the relief valve 126 can be in a lower position in the vertical configuration because the manifold 104 is thinner in the portion where the second through hole 124 and the relief valve 126 are positioned as compared to the thickness of the portion where the pressure exit 128 is located. In a vertical configuration, any pooling or buildup of liquid can exit through the relief valve 126 before it reaches the level of the pressure exit 128. The pump assembly 100 being equally operable for moisture management in either one of a vertical configuration and a horizontal configuration can eliminate the need for multiple designs of pump assemblies for various systems.

The pressure exit 128 can extend through the manifold 104 from the reservoir-facing side to the pump-facing side. For example, as shown in FIG. 9, the pressure exit 128 can fluidically connect the interior of the reservoir 106 with the pressure output 114 via a tubing 130. In some embodiments, the tubing 130 can be formed via two segments and coupled together to form a loop. In some embodiments, the tubing 130 can be a single integral piece of tubing.

The tubing 130 can be a moisture control tubing. A moisture control tubing can be configured to balance the humidity inside the tubing with the humidity outside the tubing, and/or to allow moisture to flow from a high-pressure side to a low-pressure side of the tubing. The tubing 130 can be permeable to water vapor. For example, if the humidity inside the tubing 130 is different than the humidity outside the tubing 130, the tubing 130 can allow the water vapor from the higher humidity side to penetrate the tubing 130 to travel to the lower humidity side. Moreover, as the air within the tubing 130 can be under pressure, moisture can travel from the higher-pressure interior of the tubing 130 to the lower-pressure exterior of the tubing 130, allowing reduction of relative humidity within the pressurized air in the tubing 130 to a level lower than ambient relative humidity. As such, the moisture in the air can be removed as it travels through the tubing 130. The tubing 130 can be coupled or secured to the housing 108 to prevent the tubing 130 from contacting the pump 102. This can prevent wear and tear on the tubing 130, e.g., due to vibration of the pump 102.

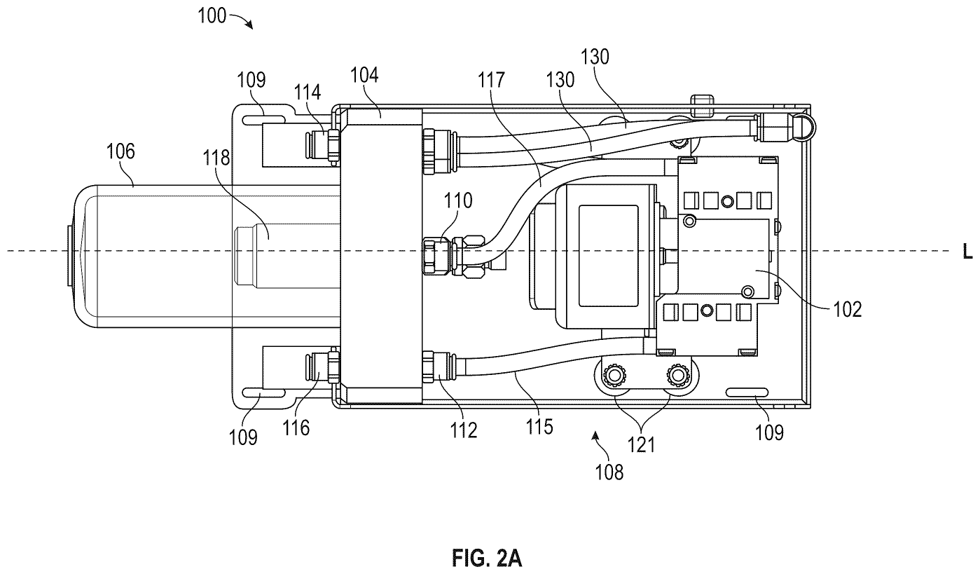

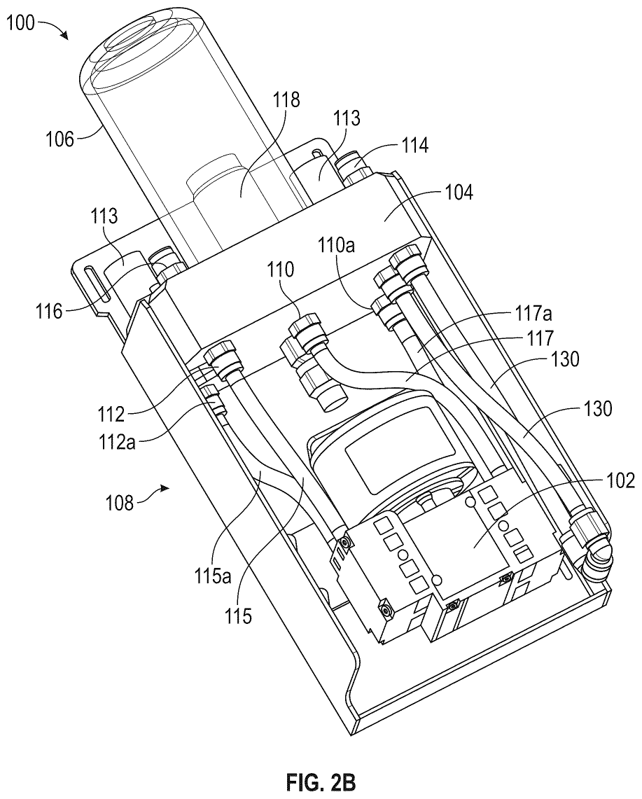

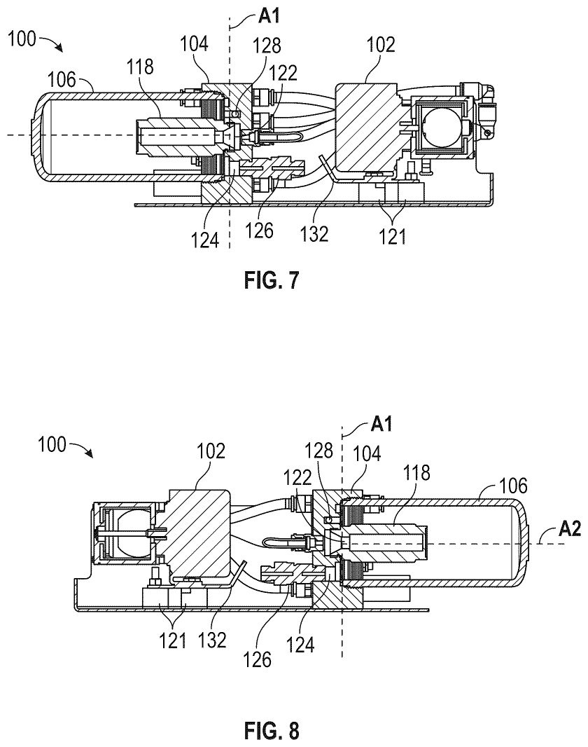

FIGS. 7 and 8 are cross-sectional side views of the pump assembly 100 taken along the central axis L shown in FIG. 2. As shown in FIGS. 7 and 8, the pump assembly 100 can include a splatter screen 132. The splatter screen 132 can be configured to prevent moisture exiting the relief valve 126 from contacting the pump 102 or any electronics in the pump assembly. In some embodiments, the splatter screen 132 can be bent at an angle or otherwise positioned to deflect moisture exiting the relief valve 126. The splatter screen 132 can be bent at about a 40 degree angle, about a 50 degree, about a 60 degree angle, about a 70 degree angle, or any value in between. Any moisture that exits the relief valve 126 can then exit the pump assembly 100 by evaporating into the surrounding environment. The use of the relief valve 126 can prevent buildup of moisture within the reservoir 106 which can eliminate the need for regular service to empty the reservoir 106.

As shown in FIGS. 7 and 8, the pressure exit 128 can be positioned at a higher point on a vertical axis A1 relative to the first through hole 122 and the second through hole 124. The pressure exit 128 can be positioned off center relative to a central axis A2 extending through the reservoir 106. The pressure exit 128 can be positioned in a plane that extends vertically through the central axis A2 of the reservoir 106. The pressure exit 128 can extend partially through the width of the manifold 104. A portion of the pressure exit 128 can extend a portion of the length of the manifold 104 as described in more detail with reference to FIG. 9 and the pressure exit pathway 128a.

The first through hole 122 can be positioned between the pressure exit 128 and the second through hole 124 along the vertical axis A1. The first through hole 122 can be positioned on the central axis A2 of the reservoir 106. The first through hole 122 can be positioned at the intersection of the central axis A2 and the vertical axis A1. The first through hole 122 can extend through a width of the manifold 104.

The second through hole 124 can be positioned at a lower point on the vertical axis A1 relative to the first through hole 122 and pressure exit 128. The second through hole 124 can extend through the width of the manifold 104. The second through hole 124 can be positioned off center relative to a central axis A2 extending through the reservoir 106. The second through hole 124 can be positioned in a plane that extends vertically through the central axis A2 of the reservoir 106.

As shown in FIGS. 7-8, the pump 102 can be mechanically affixed to a base of the housing 108. The pump 102 can be positioned a distance from the base of the housing 108. For example, as shown in FIGS. 7-8. The pump 102 can be disposed on top of one or more mounts 121. A height of the mounts 121 can determine the distance the pump 102 is positioned above the base of the housing 108.

FIG. 9 is a cutaway view of the pump assembly 100 illustrating fluid flow paths of the pump assembly 100 in operation. The arrows in FIG. 9 represent an example flow path from the pump 102 through the manifold and pump assembly 100. Positive pressure air from a pressure output of the pump can flow from the pressure port 110 of the pump 102 (hidden in FIG. 9) through the first through hole and through the filter 118 into the reservoir 106. Moisture may be collected within the reservoir 106, and excess pressure and/or moisture within the reservoir 106 can exit the reservoir 106 through the relief valve 126. Pressurized air having a reduced moisture content can exit the reservoir 106 through the pressure exit 128. The pressure exit 128 can extend via a pressure exit pathway 128a through the manifold 104 to the tubing 130. The flow can travel through the tubing 130 to the pressure output 114. The tubing 130 can be configured to reduce the relative humidity (RH), for example, by about 10 percent to about 20 percent.

FIGS. 10 and 11 illustrate example installation configurations of pump assemblies 100 in accordance with the present disclosure within example equipment environments. However, the pump assemblies 100 can equally be installed in a variety of other systems or equipment without departing from the scope of the present disclosure. As described above, the pump assembly 100 can be operably positioned in either a vertical configuration or a horizontal configuration. In both the vertical configuration and the horizontal configuration, the second through hole 124 and the relief valve 126 are positioned below the pressure exit 128. As such, in both configurations the pump assembly 100 removes moisture and manages flow to prevent damage to sensitive electronic equipment 190 positioned nearby and/or damage to electronics of the pump 102. In many instances, the electronic equipment 190 may need to be positioned near the pump assembly 100; as such, the moisture control features described herein can prevents damage from occurring, such as by removing moisture from the pressurized air provided to equipment 190, as well as by providing for contained and managed evaporation of the removed moisture within the pump assembly 100.

FIG. 10 illustrates several pump assemblies 100 positioned in horizontal configurations with various electronic equipment 190 positioned nearby. In this non-limiting example, the pump assemblies 100 generate pressure and vacuum in liquid dispensing systems of an automated sample preparation and testing apparatus. This is one example system where the pump assemblies of the present disclosure may be used. The manifold 104 can be disposed parallel to a direction of gravity in the horizontal configuration. The pump 102, the manifold 104, and the reservoir 106 can be positioned in a line parallel to a plane formed by the X and Y axis as depicted in FIG. 10 when positioned in a horizontal configuration. The pump 102, the manifold 104, and the reservoir 106 can be positioned in a line parallel to the ground when positioned in a horizontal configuration. As described herein, the pump assembly 100 can manage the moisture build up in the pump assembly to prevent damage to the electronic equipment 190 and the pump 102 when in a horizontal configuration.

FIG. 11 is illustrative of the pump assembly 100 positioned in a vertical configuration with electronic equipment 190 positioned nearby. This is another example system where the pump assemblies of the present disclosure may be used. The manifold 104 can be disposed perpendicular to a direction of gravity in the vertical configuration. The pump 102, the manifold 104, and the reservoir 106 can be positioned in a line parallel to the Z axis as depicted in FIG. 11 when positioned in a vertical configuration. The pump 102, the manifold 104, and the reservoir 106 can be positioned in a line perpendicular to the ground when positioned in a vertical configuration. As described herein, the pump assembly 100 can manage the moisture build up in the pump assembly to prevent damage to the electronic equipment 190 and the pump 102 when in a vertical configuration. While pump assemblies of the present disclosure can be used in any environment, they can be especially useful in moderate or high humidity environments.

While the above detailed description has shown, described, and pointed out novel features, it can be understood that various omissions, substitutions, and changes in the form and details of the devices, systems, and methods can be made without departing from the spirit of the present disclosure. As can be recognized, certain portions of the description herein can be embodied within a form that does not provide all of the features and benefits set forth herein, as some features can be used or practiced separately from others. Consequently, it is not intended that the present disclosure be limited to the specific embodiments disclosed herein, but that it covers all modifications and alternatives coming within the true scope and spirit of the present disclosure as embodied in the attached claims.

What is claimed is:

1. A pump assembly comprising:
a housing;
a pressure output;
a suction output;
a pump disposed at least partially within the housing and comprising a pressure port in fluid communication with the pressure output and a suction port in fluid communication with the suction output;
a reservoir; and
a manifold disposed at least partially within the housing between the pump and the reservoir, the manifold comprising:
a reservoir connection point configured to couple the reservoir to a reservoir facing side of the manifold, the reservoir connection point comprising a first through hole, an interior of the reservoir being in fluid communication with the pressure port of the pump through the first through hole;
a second through hole connecting a relief valve to the interior of the reservoir, the relief valve positioned on a pump-facing side of the manifold; and
a pressure exit extending through the manifold, the pressure exit fluidically connecting the interior of the reservoir with the pressure output via a moisture control tubing permeable to water vapor.

2. The pump assembly of claim 1, further comprising a splatter screen positioned between the relief valve and pump.

3. The pump assembly of claim 2, wherein the splatter screen is bent at an angle.

4. The pump assembly of claim 1, wherein the moisture control tubing is secured away from the pump to prevent the moisture control tubing from contacting the pump.

5. The pump assembly of claim 1, wherein the pump assembly can be positioned in a vertical configuration or a horizontal configuration.

6. The pump assembly of claim 5, wherein the relief valve is at a lower position in the reservoir than the pressure exit in both the vertical configuration and the horizontal configuration.

7. The pump assembly of claim 5, wherein the manifold is disposed parallel to a direction of gravity in the horizontal configuration and wherein the manifold is disposed perpendicular to the direction of gravity in the vertical configuration.

8. The pump assembly of claim 1, further comprising a filter positioned within the reservoir and configured to remove moisture from air passing through the filter.

9. The pump assembly of claim 8, wherein the filter is disposed adjacent to the first through hole such that fluid entering the reservoir through the first through hole passes through the filter.

10. The pump assembly of claim 8, wherein the filter is positioned at or near a center of the reservoir connection point.

11. The pump assembly of claim 1, wherein the reservoir connection point comprises interior screw threads configured to engage with exterior screw threads of the reservoir to couple the reservoir to the manifold.

12. A pump assembly comprising:
a housing;
a pump comprising a suction port and a pressure port;
a suction flow path fluidically connecting a suction output of the pump assembly to the suction port;
a pressure flow path fluidically connecting a pressure output of the pump assembly to the pressure port, the pressure flow path comprising:
a reservoir surrounding an interior volume;
a first conduit fluidically connecting the pressure port to the interior volume via a first opening of the reservoir;
a filter configured to remove moisture from gas entering the interior volume from the first conduit; and
a second conduit fluidically connecting the interior volume to the pressure output via a second opening of the reservoir; and
a relief valve configured to exhaust gas and moisture from the interior volume via a third opening of the reservoir, wherein the third opening is lower than at least the second opening when the pump assembly is installed in a horizontal configuration and when the pump assembly is installed in a vertical configuration.

13. The pump assembly of claim 12, wherein the second conduit comprises moisture control tubing permeable to water vapor.

14. The pump assembly of claim 12, further comprising a manifold mechanically fixed relative to the pump, wherein the reservoir is coupled to the manifold.

15. The pump assembly of claim 14, wherein the first, second, and third openings of the reservoir comprise through holes extending through the manifold.

16. The pump assembly of claim 15, wherein a thickness of the manifold at the second opening is greater than a thickness of the manifold at the third opening.

17. The pump assembly of claim 14, wherein the manifold is disposed parallel to a direction of gravity in the horizontal configuration and wherein the manifold is disposed perpendicular to the direction of gravity in the vertical configuration.

18. The pump assembly of claim 12, further comprising a splatter screen positioned between the relief valve and pump.

19. The pump assembly of claim 18, wherein the splatter screen is bent at an angle.

20. The pump assembly of claim 12, wherein the first and second conduits are secured away from the pump to prevent the conduits from contacting the pump.
